(19) United States
(12) Patent Application Publication
(10) Pub. No.: US 2011/0140827 A1
(43) Pub. Date: Jun. 16, 2011

(54) CIRCUIT PROTECTION DEVICE

(76) Inventor: Katsuaki Suzuki, Ryugasaki (JP)

(21) Appl. No.: 12/736,530

(22) PCT Filed: Apr. 17, 2009
(86) PCT No.: PCT/JP2009/057774

§ 371 Date: Mar. 1, 2011

(30) Foreign Application Priority Data
Apr. 18, 2008 (JP) 2008-109209

(51) Int. Cl. H01H 37/52

(52) U.S. Cl. 337/362

(57) ABSTRACT

There is provided a circuit protection device with even more possibility of protecting a circuit.

In a circuit protection device comprising a circuit switching element which comprises a bimetal element as a circuit switching component and a movable terminal as well as a PTC element,
(1) the PTC element and the movable terminal are connected electrically in parallel;
(2) the circuit switching element is able to cut off current flowing through the circuit switching element by moving, through the actuation of the bimetal element at its actuating temperature (Top), the movable terminal positioned to pass current, and is able to pass current through the circuit switching element by moving, through the resetting of the bimetal element at its reset temperature (Tcl), the movable terminal positioned to pass current;
(3) the actuating temperature (Top) of the bimetal element is at least 20° C. higher than the reset temperature (Tcl) of the bimetal element;
(4) a trip temperature (Ttr) or the PTC element is at least 10° C. higher than the actuating temperature of the bimetal element; and
(5) the bimetal element is placed between the PTC element and the movable terminal.

### FIELD OF THE INVENTION

This invention relates to a circuit protection device (or a circuit protection element); more specifically, it relates to a circuit protection device comprising a circuit switching element comprising a bimetal element and a movable terminal, and a PTC element, as well as to an electrical circuit (or an electrical apparatus) having such a protection device. Such a circuit protection device may be used as a protection element in electrical circuits using various high voltage (preferably 12 V or larger, for example 24V or higher) or high current (preferably 15 A or higher, for example 30 A or larger) batteries, which are, for example, used in electric cars, cordless cleaners, power tools, wireless base stations, and the like. It is noted that the above mentioned voltage and current are normal voltage and current when an electric device (various electric devices including a battery) which uses the circuit protection device according to the present invention works without a problem.

### BACKGROUND ART

In various electrical circuits, a circuit protection device is incorporated into its circuit in order to protect electrical/electronic devices and/or electrical/electronic components incorporated in the circuit when a voltage which is larger than the rated voltage is applied to the circuit and/or when a current which is larger than the rated current through the circuit.

For such a circuit protection device, the use of a bimetal element as a circuit switching element and a PTC element connected in parallel has been proposed (see the patent reference below). In such a circuit protection device, substantially all of the current flowing through the circuit under normal operating conditions (i.e. under conditions of a voltage equal to or below the rated voltage and a current equal to or below the rated current) flows between the contacts of the circuit switching element, which are in contact with each other. Under conditions of an overcurrent, for example, the bimetal element of the circuit switching element rises in temperature and is actuated, and its contact is separated from the corresponding stationary contact and opened, so that the current is diverted to the PTC element. As a result, the PTC element trips into a high temperature, high resistance state through the overcurrent, substantially cutting off the current flowing through the PTC element. At this point, the high temperature of the PTC element maintains the bimetal part at high temperature, thereby maintaining the open state of the circuit switching element. In other words, the latched state of the circuit switching element is maintained. It is said that, in such a circuit protection device, there is no need to switch the current and therefore there is no arcing at the contacts of the circuit switching device.

### PRIOR PATENT REFERENCE

Patent Reference 1: Japanese Patent Kohyo Publication No. 1999-512598

### DISCLOSURE OF THE INVENTION

### Problems to be Solved by the Invention

The inventor studied the abovementioned circuit protection device, as a result of which it has been noticed that, in a circuit protection device wherein the PTC element is merely connected in parallel relative to the circuit switching element, when the circuit switching element is actuated and the contacts of the bimetal element are separated from its corresponding stationary contacts, arcing occurs at the contacts of the circuit switching element, and in the worst case, may cause the contacts to weld and form a welded area. When such a welded area is formed, the circuit protection device will not function and will not be able to protect the electrical/electronic devices and/or the electrical/electronic components incorporated in the circuit. Therefore, the problem that the present invention aims to solve is to provide the abovementioned circuit protection device with an even more improved possibility of protecting the circuit. In other words, when instantaneously shutting off current flowing between the contacts, there is a problem in that a welded area is formed between these contacts.

### Means to Solve the Problems

The present invention provides a circuit protection device which comprises a circuit switching element comprising a bimetal element as a circuit switching component and a movable terminal as well as a PTC element, the circuit protection device being characterized by:

(1) the PTC element and the movable terminal being connected electrically in parallel;

(2) the circuit switching element being able to cut off current which flows through the circuit switching element by moving, through actuation of the bimetal element at its actuating temperature (Top), the movable terminal positioned to pass the current, and being able to pass current through the circuit switching element by moving, through resetting of the bimetal element at its reset temperature (Tcl), the movable terminal positioned to pass current;

(3) the actuating temperature (Top) of the bimetal element being at least 20° C. higher than the reset temperature (Tcl) of the bimetal element;

(4) a trip temperature (Ttr) of the PTC element being at least 10° C. higher than the actuating temperature of the bimetal element; and

(5) the bimetal element being placed between the PTC element and the movable terminal. The present invention also provides an electrical circuit comprising such a circuit protection device, and further provides an electrical apparatus comprising such an electrical circuit.

### Effect of the Invention

When a circuit protection device of the present invention is incorporated in an electric circuit, the formation of a welded area between contacts on the movable terminal (also called movable contacts) and their corresponding contacts on the stationary terminal may be further suppressed. As a result, the circuit protection function of the circuit protection device is further improved.

### BRIEF EXPLANATION OF THE DRAWINGS

FIG. 1 shows schematically an electrical circuit of an electrical apparatus incorporating the circuit protection device of the present invention.

FIG. 2 shows a schematic cross-section of one embodiment of the circuit protection device of the present invention.

FIG. 3 shows schematically an exploded perspective view of the circuit protection device in FIG. 2.

FIG. 4 shows a schematic cross-section of one embodiment of the circuit protection device of the present invention.

FIG. 5 shows a temperature vs. resistance curve for the circuit protection device of the present invention.

FIG. 6 shows the change in time vs. current/voltage in smoothed out lines when DC30V/50A is applied to an electrical circuit incorporating the circuit protection device of the present invention.

FIG. 7 shows the change in time vs. current/voltage in smoothed out lines when DC30V/100A is applied to an electrical circuit incorporating the circuit protection device of the present invention.

### EXPLANATION OF THE REFERENCES

1—circuit protection device; 3—electrical circuit;
5—electrical component; 7—power source;
10—PTC element; 12—circuit switching element;
14—bimetal element; 16—movable terminal;
18, 19—contact; 20, 21—stationary terminal;
22, 23—contact; 30—lower side lead;
32—upper side lead; 38—base plate; 40—spacer;
42—upper plate; 44—pin; 46—casing; 48—opening;
50—insulating material; 52—adhesive.

### EMBODIMENTS TO CARRY OUT THE INVENTION

As a result of studying the problem of the welded area being formed at the contacts of the circuit switching element, in the circuit protection device comprising the PTC element and the circuit switching element, when adopting a arrangement using a bimetal element as the circuit switching component whereby the current flowing through the circuit switching element is cut off/turned on by the actuation of the bimetal element (in other words, actuation and reset as described below) to move the movable terminal,

it has been found to be desirable regarding the abovementioned problem of the welded area being formed

that a circuit switching element comprising a bimetal element and a movable terminal is used which is configured to cut off the current flowing through the circuit switching element by means of the bimetal element actuating (from the reset state) and turn on the current flowing through the circuit switching element by means of the bimetal element resetting (from the actuated state); and

that when placing the bimetal element between the PTC element and the movable terminal,

(a) the actuating temperature (Top) of the bimetal element is at least 20° C. higher than its reset temperature (Tcl), and

(b) the trip temperature (Ttr) of the PTC element is at least 10° C. higher than the actuating temperature of the bimetal element.

When the temperature of a bimetal element rises to or above a certain temperature or above, the shape of the bimetal element changes to a different shape through the actuation of the bimetal element. The temperature at which it actuates is called the actuating temperature (Top). During such actuation, the action of the movable contacts of the movable terminal in a current carrying state moving away from the corresponding stationary contacts of the stationary terminal and separating these contacts from each other is macroscopically an instantaneous action. When this action is seen microscopically, it can be considered as a gradually separating action in the continuous and extremely short time in which the contacts separate. At the beginning of this extremely short time, the rated current flows between the contacts, and at the end of this extremely short time the current is shut off between the contacts. In other words, at the beginning of this extremely short time, the resistance between the contacts is substantially zero, and at the end of this extremely short time, the resistance is increased infinitely.

Therefore, when the PTC element has already tripped and is in a high-resistance state before the contacts are separated, the current that had been flowing between the contacts is not diverted smoothly to the PTC element. Taking this into consideration, it is desirable for the PTC element to have a sufficiently low resistance when the bimetal is actuated and the movable contacts of the movable terminal separate from their corresponding contacts. The trip temperature (Ttr) of the PTC element needs to be higher than the actuating temperature (Top) of the bimetal element; as a result of the inventors' experience and experimental studies, it has been found that at least 30° C. higher is preferred, at least 20° C. higher is more preferred, and at least 10° C. higher is particularly preferred.

The PTC element becomes highly resistant quickly after the actuation of the bimetal when the temperature difference between Ttr and Top is appropriately large, so that overcurrents can be cut off immediately. Taking this into consideration, it has been thought that the abovementioned temperature differences are appropriate. In this case, when a polymer PTC element as described below is used as the PTC element, its initial resistance (i.e. the resistance in the state before tripping) is considerably smaller, for example roughly 1/100 compared with a ceramic PTC element, so from this point, the use of a PTC element is particularly preferred.

Further, when the temperature difference (ΔT1) between Ttr and Top is excessively large, the duration of the overcurrent flowing through the PTC element becomes long, and in some cases this may not necessarily be desirable from the standpoint of the circuit protection. Taking this into consideration, the temperature difference between the trip temperature (Ttr) of the PTC element and the actuating temperature (Top) of the bimetal element is preferably 70° C. or less, more preferably 50° C. or less, and particularly preferably 40° C. or less. Therefore, the range of ΔT1 is, for example, preferably 10° C.≦ΔT1≦70° C., more preferably 10° C.≦ΔT1≦50° C., and particularly preferably 10° C.≦ΔT1≦40° C.

It is noted that the trip temperature of a PTC element denotes the temperature at which the resistance of the PTC element increases rapidly (for example 10³-10⁶ times) in the vicinity of a certain temperature when the temperature of the PTC element is raised. With respect to this temperature, information provided by the manufacturer or seller (for example catalogs, specifications, etc.) may be referred to for commercially available PTC elements. For example, in catalogs of Tyco Electronics Raychem, temperatures called actuating temperatures (typical values) are listed as trip temperatures.

Further, the view has been reached that, when the PTC element became highly resistant and heated up, in order to provide its heat to the bimetal element and maintain the bimetal element in the actuated state, it is desirable to place the bimetal element adjacently to the PTC element with a gap in between (thus these elements face to each other across the gap). Specifically, it has been found that the bimetal element is preferably placed between the PTC element and the movable terminal.

In addition, the bimetal element in the actuated state decreases in temperature, and when the temperature is equal to or below a certain temperature, it reverts toward its original shape, as a result of which the separated contacts return to a contact state. This temperature is called the reset temperature (Tcl). It has been seen that, when this reset temperature is not very different from the abovementioned actuating temperature, an overcurrent may flow again in a state wherein the temperature has not sufficiently decreased around the circuit protection device, i.e. in a state wherein the abnormal condition occurring in the circuit has not been resolved, so that the bimetal will actuate again. As a result of further study, it has been found that the actuating temperature (Top) of the bimetal element is preferably at least 20° C. higher than the reset temperature (Tcl), and more preferably at least 30° C. higher. With respect to the actuating temperature and the reset temperature for the commercially available bimetal elements, information provided by the manufacturer (for example catalog data, specification, etc.) may be referred to.

In the circuit protection device of the present invention, the circuit switching element comprises a bimetal element, as the circuit switching component as well as a movable terminal. The bimetal element is a drive member using a bimetal. In the circuit protection device of the present invention, when current flowing in the movable terminal (or if contacts are provided thereon, between these contacts (i.e. movable contacts)) driven by the bimetal element increases over a prescribed current and becomes excessive, it changes from a certain shape (called a first shape as described below) to another shape (called a second shape as described below), as a result of which, the movable terminal (or its contacts) in mutual contact functions as a type of switch so structured as to separate from the terminal with which it is in contact (for example the contacts of the stationary terminal or its contacts (i.e. stationary contacts)), or conversely to have separated contacts come in mutual contact. Any known bimetal element may be used for the bimetal element itself. It is noted that such contact may be any one between the terminals, between the contacts provided on the terminals or between the terminal and the contacts.

In such a bimetal element, the shape at the lower temperature is called the first shape; when the temperature of the element is increased from that state and the temperature exceeds a certain temperature, the bimetal element switches to a second shape. Also, when the temperature of the bimetal element in the second shape is decreased and the temperature goes below a certain temperature, the bimetal element returns to the first shape. Changing from the first shape to the second shape is called “actuating” herein for convenience, and changing from the second shape to the first shape is called “resetting” for convenience. Such a change in shape is utilized to separate the movable terminal (or the contacts provided thereon), which has been in a contact state, from the stationary terminal, or to have the movable terminal (or the contacts provided thereon) come in contact with the stationary terminals. In other words, the shape change of the bimetal element is utilized as a driving force to change the position of the movable terminal (or the contacts provided thereon).

The temperature at which the first shape changes to the second shape is called “actuating temperature (Top)”, and the temperature at which the second shape changes to the first shape is called “reset temperature (Tcl)”. Normally, Top is higher than Tcl. If the reset temperature is excessively close to the actuating temperature, this will cause chattering, in which the switching of the contacts is repeated when the equipment is in an abnormal state, so that the circuit protection device will not function normally in response to an overcurrent. In the circuit protection device of the present invention, Top is at least 20° C. higher than Tcl, preferably at least 30° C. higher, and more preferably at least 40° C. higher, for example 45° C. higher.

It is noted that if the reset temperature is excessively low, the duration of period that the bimetal element causes the circuit protection device to be latched becomes long, which means that the time it takes for the circuit protection element to return to its normal state takes longer, which in some cases may not be desirable from the standpoint of convenience in using the electrical equipment in which the circuit protection element is incorporated. For example, time may be required before an electrical equipment that has stopped through an overcurrent caused by a high load (for example a power drill) can be used again. Taking this into consideration, the temperature difference (ΔT2) between the actuating temperature (Top) and the reset temperature (Tcl) of the bimetal element is, for example, preferably 60° C. or lower, more preferably 55° C. or lower, and particularly preferably 50° C. or lower. Thus, the range of ΔT2 is, for example, preferably 20° C.≦ΔT2≦60° C., more preferably 30° C.≦ΔT2≦55° C., and particularly preferably 40° C.≦ΔT2≦50° C.

For the movable terminal of the circuit switching element as described above, one using platinum, gold, silver, copper, carbon, nickel, tin, lead, and alloys thereof (for example tin-lead alloy, silver-nickel alloy, etc.) as the contact material may be mentioned as particularly desirable for use in the circuit protection device of the present invention. Among them, a movable terminal using silver or a silver alloy (e.g. silver-nickel alloy or the like) as the contact material is particularly preferred. It is of course that the above explanation as to the movable terminal is also applicable to the material which forms the movable contacts. It is noted that in the circuit protection device of the present invention, the gap between the movable terminal and the stationary terminal or the gap between the movable contacts and the stationary contacts is preferably relatively small, and it is preferably 0.5-4 mm, particularly 2 mm or less, more preferably 0.7-2 mm, particularly preferably 0.8-1.5 mm, for example about 1 mm.

In the circuit protection device of the present invention, nickel, copper, manganese, iron, chrome, zinc, molybdenum, and alloys thereof (for example nickel-copper, nickel-iron and the like) for example may be mentioned as particularly desirable for use in the bimetal element. Among them, bimetal elements using nickel-copper-manganese, nickel-iron, and the like, as the material thereof are particularly preferred.

In the circuit protection device of the present invention, the PTC element connected in parallel to the circuit switching element may be a conventional PTC element that is itself used as a circuit protection device, and its conductive element may be made of a ceramic or of a polymer material. A particularly preferred PTC element is one called a polymer PTC element, and a PTC element comprising a conductive polymer element wherein conductive fillers (for example carbon, nickel, nickel-cobalt fillers) are dispersed in a polymer material (for example polyethylene, polyvinylidene fluoride, etc.) may be suitably used.

When an electric device in which the circuit protection device of the present invention is incorporated in a prescribed circuit performs its intended function normally, substantially all of the current flowing in the circuit passes through the circuit switching element. Therefore, in the circuit protection device of the present invention, the resistance of the PTC element (resistance before tripping, normally resistance at room temperature) has a resistance value of at least 10 times the electrical resistance that the movable terminal inherently has (or the resistance between the contacts provided thereon; these resistance values are normally 0.5 to 20 milliohms), preferably at least 50 times, more preferably at least 100 times, and particularly preferably at least 300 times.

FIG. 1 shows an electrical circuit 3 incorporating the circuit protection device 1 of the present invention (enclosed in broken lines). The circuit 3 has a prescribed electrical element (for example an electrical/electronic device or component, etc.) 5, and the circuit protection device 1 and a power source 7 are connected in series thereto. The electrical element 5 is shown as a single element, but this denotes a single electrical element or an aggregate of a plurality of electrical elements included in the circuit 3.

The circuit protection device 1 of the present invention comprises a PTC element 10 and a circuit switching element 12. The circuit switching element 12 comprises a bimetal element 14 and a movable terminal 16. The movable terminal 16 has movable contacts 18 and 19 close to its ends. The movable terminal 16 moves as shown by the arrows through the actuation of the bimetal element 14 to come into contact with, or separate from, the stationary contacts 22 and 23 provided on the facing stationary terminals 20 and 21.

In the illustrated embodiment, the contact 18 of the movable terminal that had been in contact with the contact 22 of the stationary terminal 20 and the contact 19 of the movable terminal that had been in contact with the contact 23 of the stationary terminal 21 are in a separated state from the terminals 20 and 21 through the upward movement of the movable terminal 16 due to the actuation based on the temperature increase of the bimetal element. In this state, all the current flowing through the circuit 3 flows through the PTC element, as a result of which the PTC element heats up, such heat maintaining the actuated state of the bimetal element.

Conversely, from the state shown in FIG. 1, the movable terminal moves through the temperature of the bimetal element 14 decreasing and the bimetal resetting, so that the contacts 18 and 22, and the contacts 19 and 23 come mutually in contact. In this state, substantially all the current flowing through the circuit 3 flows through the movable terminal side, and virtually no current flows through the PTC element side.

In this way, when the bimetal element actuates, the contacts 18 and 22, and the contacts 19 and 23 separates from contact state, while conversely, when the bimetal element resets, the contacts 18 and 22, and the contacts 19 and 23, which were in a separated state, come mutually in contact. Thus, in the contact state, the PTC element and the circuit switching element 12 are connected electrically in parallel, or if not directly connected electrically in parallel, they are so configured that they could be connected in parallel.

In a normal state wherein the electrical element 5 is functioning normally and a prescribed current is flowing through the electrical circuit 3, the contacts 18 and 22, and the contacts 19 and 23 are mutually in contact. From this state, the bimetal element 14 actuates if there is an overcurrent, and the state changes to one shown in FIG. 1.

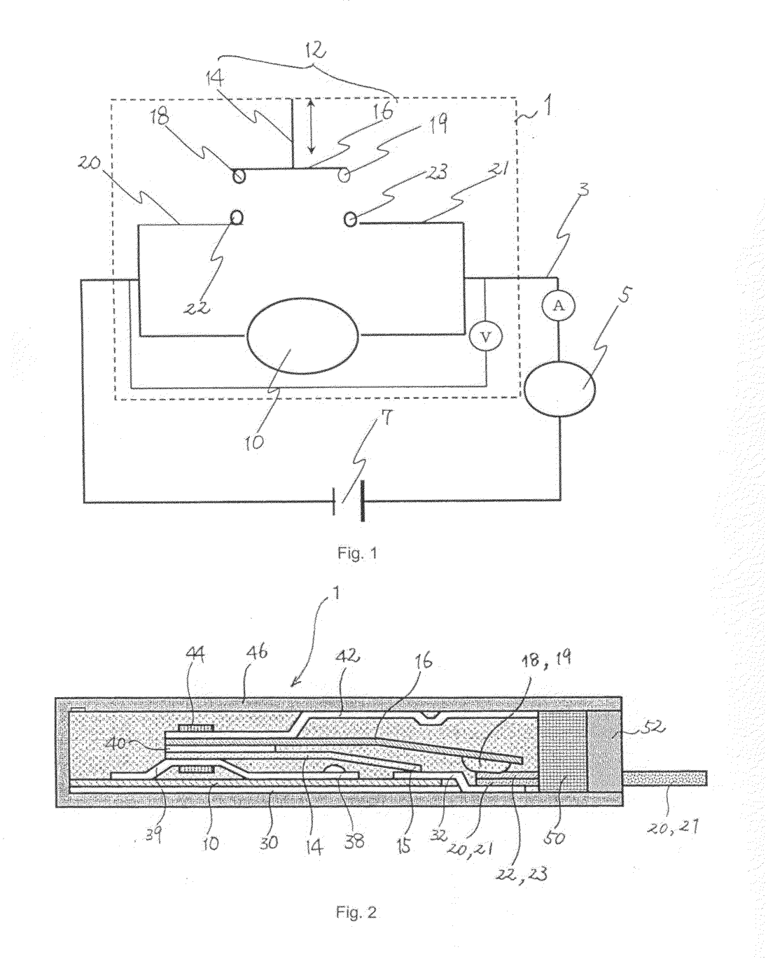

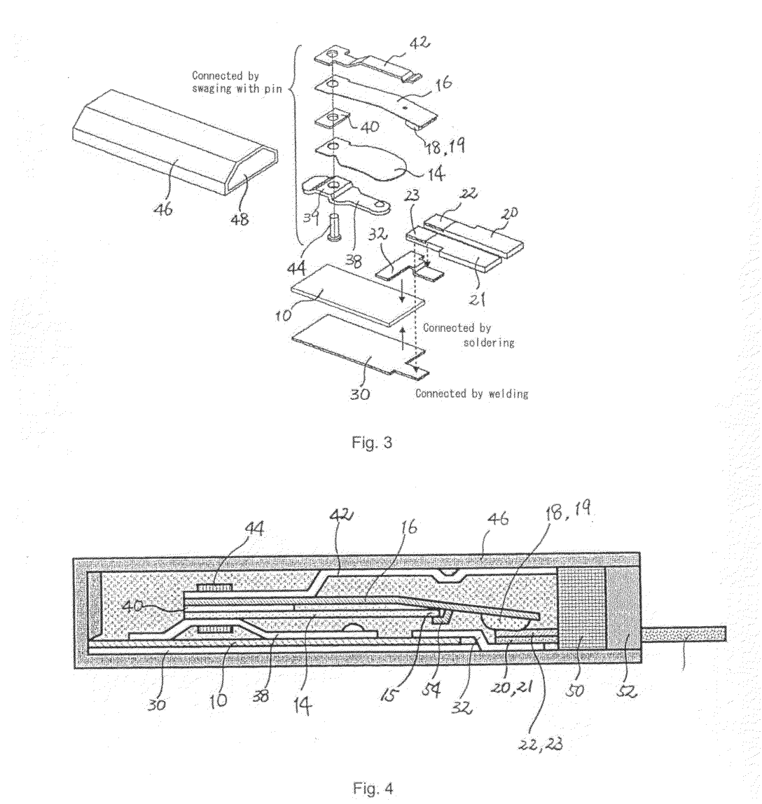

A more specific example of an embodiment of the circuit protection device 10 of the present invention is shown as a schematic cross-section in FIG. 2, and as a schematic exploded perspective in FIG. 3. In the illustrated circuit protection device 1 of the present invention, a lower side lead 30 and an upper side lead 32 are disposed on the lower side and the upper side respectively of the PTC element 10. These are electrically connected by, for example, soldering. Further, stationary terminals 21 and 20 are electrically connected to these leads 30 and 32, respectively, by for example resistance welding or ultrasound welding. The stationary terminals 20 and 21 are connected to prescribed electric circuit terminals and the like, so that the circuit protection device of the present invention is disposed in series in the electrical circuit.

A base plate 38 is also disposed on the PTC element 10. In the illustrated embodiment, the base plate 38 has a portion 39 that protrudes upwards; the bimetal element 14, a spacer 40, the movable terminal 16, and an upper plate 42 are disposed in this order over this portion 39. These are integrated by swaging with a pin 44 as shown in FIG. 2. It is noted that the connection between the base plate 38 and the PTC element may be done with any appropriate method; it may, for example, be done by a solder connection.

In the illustrated embodiment, the bimetal element 14 is in a reset state (i.e. the electrical circuit is functioning normally). The tip 15 of the bimetal element 14 is separated from the movable terminal 16. As a result, the contacts 18 and 19 disposed on the end of the movable terminal are in contact with the contacts 22 and 23 of the stationary terminals 20 and 21. Thus, when the circuit protection device in this state is disposed in an electrical circuit (not illustrated) and current flows in the circuit, the current flows in the order of stationary terminal 20->contact 22->contact 18->(end of movable terminal)->contact 19->contact 23->stationary terminal 21.

In the illustrated embodiment, if an abnormality occurs in the electrical circuit and an overcurrent flows, the proximity of the end of the movable terminal 16 rises in temperature, and as the temperature of the movable terminal 16 rises, the heat is transferred to the bimetal element 14 so that the bimetal element 14 actuates. As a result, the bimetal element 14 inverts so that its end 15 bends upwards to raise the movable terminal 16; the contact state between the contacts of the movable terminal and the contacts of the stationary terminals is released, i.e. the electrical connection between the contact 22 and the contact 18, and the electrical contact between the contact 19 and the contact 23 are disconnected. At this point, the PTC element 10 is not yet in a tripped state, and (i.e. since ΔT1 is at least 10° C.), it is in a sufficiently low resistance state so that the current is diverted and flows in the order of stationary terminal 20->upper side lead 32->PTC element->lower side lead 30->stationary terminal 21.

If there is no change in the abnormality of the electrical circuit, the overcurrent flows through the PTC element 10, after which the PTC element 10 trips, as a result of which the current flowing through the electrical circuit is substantially cut off so that the electrical circuit can be protected. It is noted as can be easily understood from the previous explanation, the circuit switching element in the circuit protection device of the present invention is a non-current carrying type of circuit switching element, where the current flows in the movable terminal or the movable contacts provided thereon and the current does not flow through the bimetal element itself.

In the circuit protection device of the present invention, since ΔT2 is at least 20° C., when the temperature of the bimetal element 14 decreases to a temperature 20° C. or lower than the actuating temperature, the actuated state returns to the reset state shown in FIG. 2, as a result of which, the separated contacts 18 and 19, and contacts 22 and 23 returns to a contact state, as a result of which the current flowing through the circuit flows, from a state where the current was flowing in the order of stationary terminal 20->PTC element 10->stationary terminal 22, to one where the current flows in the order of stationary terminal 20->movable terminal 16->stationary terminal 22, as in the normal state.

As shown in FIG. 2 and FIG. 3, the circuit protection device described above is inserted inside a casing 46 through its opening 48; the opening is sealed with an insulating resin 50 and adhesive 52.

FIG. 4 shows another embodiment of the circuit protection device of the present invention as a schematic cross-section, as in FIG. 2. In the illustrated embodiment, the movable terminal 16 has a hook 54 on its lower surface and the construction is such that the tip 15 of the bimetal element 14 latches to the hook 54. By providing such a hook, the force generated by the actuation/reset of the bimetal element 14 may be transmitted more reliably to the movable terminal 16. Also, the heat generated in the proximity of the contacts is transmitted more quickly to the bimetal element 14 and the sensitivity of the circuit protection device of the present invention is improved.

### Example 1

The electrical circuit 3 shown in FIG. 1 incorporating the circuit protection device 10 shown in FIG. 2 was constructed using the following commercially available polymer PTC element 10, bimetal element 14, and electrical component 5 (resistor, resistance Rf=0, 17Ω). PTC element: manufactured by Tyco Electronics Raychem, product name: RXE135 (In Tyco Electronics Raychem Plaque No. PLQ-6NXEC120 A), trip temperature (Ttr): 125° C. Circuit switching element 12 (bimetal switch composed of movable terminal 16 and bimetal element 14): manufactured by Sensata Technologies, product name: Thermal Protector 9700K21-215, distance between movable terminal and stationary contact: 1 mm, resistance between movable contacts: 11.6 mΩ, actuating temperature (Top): 110° C., reset temperature (Tcl): 60° C., stationary contact: Ag—Ni+Silver Cadmium oxide, movable contact: Steel-Copper+Silver Cadmium oxide

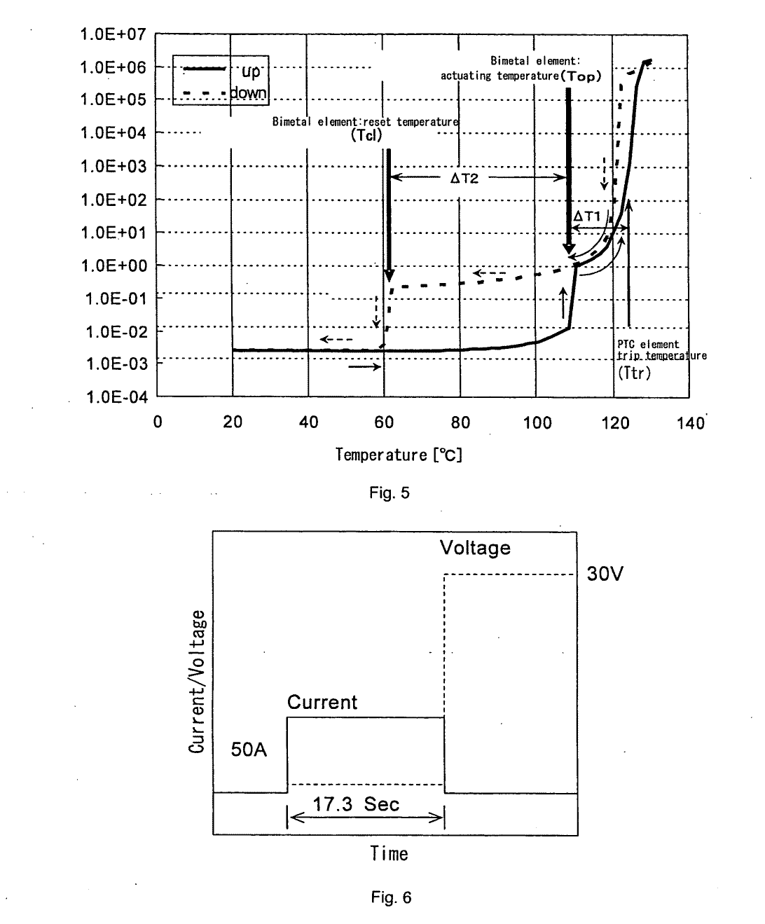

The relationship between ambient temperature around the circuit protection device and resistance of such circuit protection device is shown as a schematic graph in FIG. 5. Specifically, the circuit protection device was placed in a constant temperature vessel and its temperature increased from 20° C. to 130° C., then returned again to 20° C. It is noted that the resistance values during this temperature change were measured. The temperature was increased in increments of 2° C., and maintained at the increased temperature for 1 minute.

In FIG. 5, rising temperature is shown by a solid line, and falling temperature is shown by a broken line. When the temperature is increased, the resistance between the contacts of the stationary terminals and the movable terminal increases gradually. When the temperature reaches 110° C., the bimetal element actuates, so that the contact between the contacts of the movable terminal and the stationary terminal is released and current runs between the stationary terminal and the PTC element. As a result, the resistance of the circuit protection device increases rapidly to substantially the resistance of the PTC element, but the resistance value is still low. After this, as the temperature rises, the resistance of the PTC element reaches so higher as about 1000Ω at 125° C., so that it can substantially cuts off the current flowing in the circuit protection device.

When the temperature is decreased after this, the resistance decreases as is shown by the broken line. When the temperature reaches 60° C., the bimetal element resets, as a result of which the resistance decreases rapidly from the resistance of the PTC element to the original resistance between the contacts of the movable terminal and the stationary terminals. It is noted that ΔT1 and ΔT2 are shown in the graph in FIG. 5.

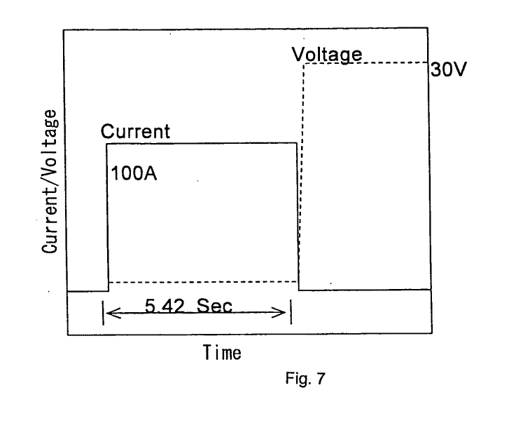

DC30V/50A was applied to the circuit in FIG. 1 in which the circuit protection device arranged as described in the above was incorporated and the waveforms of the current (current flowing in the bimetal switch) and the voltage (voltage between the two ends of the circuit protection device, i.e. the voltage drop across the circuit protection device, measured by V in FIG. 1) were measured with an ammeter A and a voltmeter V incorporated in the circuit shown in FIG. 1. The waveforms of the measured current (solid line) and voltage (broken line) are shown in FIG. 6 (the oscillating waveforms are shown smoothed out). In the graph in FIG. 6, the vertical axis is the voltage or current, and it can be seen that the bimetal element actuates at 17.3 seconds after the application to shut off the current. Further, as in FIG. 6, FIG. 7 shows similarly the relationship between current/voltage and time when DC30V/100A is applied instead of DC50V/50A. In this case, it can be seen that the bimetal switch actuates at 5.42 seconds after application and shuts off the current. In either case, the circuit protecting function of the circuit protection device of the present invention was confirmed.

1. A circuit protection device which comprises a circuit switching element comprising a bimetal element as a circuit switching component and a movable terminal, and a PTC element, the circuit protection device being characterized by:
(1) the PTC element and the movable terminal being connected electrically in parallel;
(2) the circuit switching element being able to cut off current which flows through the circuit switching element by moving, through actuation of the bimetal element at an actuating temperature (Top), the movable terminal positioned to pass the current, and being able to pass current through the circuit switching element by moving, through resetting of the bimetal element at a reset temperature (Tcl), the movable terminal positioned to pass current;
(3) the actuating temperature (Top) of the bimetal element being at least 20° C. higher than the reset temperature (Tcl) of the bimetal element;
(4) a trip temperature (Ttr) of the PTC element being at least 10° C. higher than the actuating temperature of the bimetal element; and
(5) the bimetal element being placed between the PTC element and the movable terminal.

2. The circuit protection device according to claim 1, characterized by the circuit switching element being a non-current carrying type circuit switching element wherein the current flows through the movable terminal or the movable contacts provided thereon and the current does not flow through the bimetal element itself.

3. The circuit protection device according to claim 1, characterized by the PTC element being a polymer PTC element.

4. The circuit protection device according to claim 1, characterized by the PTC element having at least 10 times the resistance of the resistance of the bimetal element.

5. An electric circuit comprising the circuit protection device according to claim 1.

6. The circuit protection device according to claim 2, characterized by the PTC element being a polymer PTC element.

7. The circuit protection device according to claim 2, characterized by the PTC element having at least 10 times the resistance of the resistance of the bimetal element.

8. The circuit protection device according to claim 3, characterized by the PTC element having at least 10 times the resistance of the resistance of the bimetal element.

9. An electric circuit comprising the circuit protection device according to claim 2.

10. An electric circuit comprising the circuit protection device according to claim 3.

11. An electric circuit comprising the circuit protection device according to claim 4.
